(19) United States
(12) Patent Application Publication
(10) Pub. No.: US 2013/0206167 A1
(43) Pub. Date: Aug. 15, 2013

(54) CLEANING SYSTEM FOR SOLAR REFLECTORS/COLLECTORS

(71) Applicants: Yehoshua Mor, Jerusalem (IL); Dmitri Levkov, El'Azar (IL); Boaz Grosman, Mevaseret Zion (IL)

(72) Inventors: Yehoshua Mor, Jerusalem (IL); Dmitri Levkov, El'Azar (IL); Boaz Grosman, Mevaseret Zion (IL)

(21) Appl. No.: 13/695,071

(22) PCT Filed: Apr. 28, 2011
(86) PCT No.: PCT/IL11/00338

§ 371 Date: Dec. 25, 2012

Related U.S. Application Data
(60) Provisional application No. 61/329,111, filed on Apr. 29, 2010.

(51) Int. Cl. B08B 1/00

(52) U.S. Cl. CPC B08B 1/006; B08B 1/008
USPC 134/6; 15/102

(57) ABSTRACT

A system and method for cleaning a reflector/collector pivotally mounted on a pivoting mechanism, the system including a wiping device disposed on one side of the reflector/collector, and a counterbalance element coupled to the wiping device over a top end of the reflector/collector, wherein the pivoting mechanism causes the reflector/collector to pivot between a first state wherein the wiping device moves to the top end of the reflector/collector by means of gravity and cleans the reflector/collector, and a second state wherein the wiping device moves to a bottom end of reflector/collector by means of gravity and cleans the reflector/collector.

### RELATED APPLICATIONS

The present invention claims priority from U.S. Provisional Patent Application No. 61,329,111 filed 29 Apr. 2010.

### FIELD OF THE INVENTION

The present invention relates generally to the field of solar energy system devices. More specifically, the present invention relates to reflectors and collectors used in these solar energy systems, particularly heliostats and parabolas.

### BACKGROUND OF THE INVENTION

Solar energy systems can be divided into two main types: Thermal solar systems and Photo Voltaic (PV) systems. The Thermal systems are based on the principle of collecting the sun's rays and reflecting (and concentrating) them via a reflector, a heliostat (an instrument in which a mirror is automatically moved to track the sun's motion and reflect sunlight in a constant direction) or a parabolic mirror into a boiler or receiver. The PV systems are based on collecting the sun's rays in solar cell panels or collectors (such as a heliostat collector) and convert the collected sun rays to electricity within the PV itself. In all such systems, the cleanness of the reflectors and collectors is very important for efficiency of the process. In order to keep the reflectors and collectors clean, a few points must be taken into account: quality of cleaning and cleaning schedule.

Today, it is common to clean the reflectors' or collectors' surfaces, in the field, by a specially designed mechanism. The mechanism is moved along the field of reflectors or collectors and cleans them, one by one or part by part. To move the mechanism along the field, a special dedicated vehicle and an operator are required frequently for the task. The washing process utilizes liquids in order to achieve the desired cleanness. Other devices include robots or motorized drive units for cleaning the surfaces of the reflectors or collectors.

Accordingly, there is a long felt need for a simple, inexpensive system for cleaning reflectors or collectors, and it would be very desirable if such system required little or low power for operation.

### SUMMARY OF THE INVENTION

There is provided according to the present invention a system for cleaning a reflector/collector pivotally mounted on a pivoting mechanism, the system including a wiping device disposed on one side of the reflector/collector, and a counterbalance device coupled to the wiping device over a top end of the reflector/collector, wherein the pivoting mechanism causes the reflector/collector to pivot between a first state wherein the wiping device moves to the top end of the reflector/collector by means of a counterbalance force exerted by the counterbalance device on the wiping device, and the wiping device cleans the reflector/collector, and a second state wherein the wiping device moves to a bottom end of reflector/collector by means of gravity and cleans the reflector/collector.

Preferably, the counterbalance device is selected from the group including a counterweight, a counter spring, and an anchor coupled to a fixed element near the reflector/collector, such as the pylon holding the reflector/collector.

There is further provided, according to the present invention, a method of cleaning a surface of a reflector/collector pivotally mounted on a pivoting mechanism, the method including disposing a wiper on the surface of the reflector/collector, counterbalancing the wiper over a top end of the reflector/collector, and pivoting the reflector/collector by means of the pivoting mechanism between a first state wherein the wiping device moves to the top end of the reflector/collector by means of a counterbalance force from the counterbalance device and cleans the reflector/collector, and a second state wherein the wiping device moves to a bottom end of reflector/collector by means of gravity and cleans the reflector/collector.

### BRIEF DESCRIPTION OF THE DRAWINGS

The present invention will be further understood and appreciated from the following detailed description taken in conjunction with the drawings in which:

FIG. 1 is a top perspective view of a system for cleaning reflectors or collectors including a counterweight, constructed and operative in accordance with one embodiment of the present invention;

FIG. 2 is a side view of the system for cleaning of FIG. 1;

FIG. 3 is a schematic side view of a system including a Pylon anchor for cleaning reflectors or collectors, constructed and operative in accordance with an alternative embodiment of the present invention;

FIG. 4 is a schematic side view of a system including a spring counter force for cleaning reflectors or collectors, constructed and operative in accordance with another embodiment of the present invention;

FIG. 5 is a schematic side view of a system including a counterweight with Pulley Block for cleaning reflectors or collectors, constructed and operative in accordance with a further embodiment of the present invention;

FIG. 6 is a side view of a system including a dynamic latch for cleaning reflectors or collectors, constructed and operative in accordance with an alternative embodiment of the present invention; and

FIG. 7 is a side view of a system including a static latch for cleaning reflectors or collectors, constructed and operative in accordance with an alternative embodiment of the present invention.

### DETAILED DESCRIPTION OF THE INVENTION

The present invention relates to a system and method for cleaning the surface of a pivoting reflector mirror or collector. The system takes advantage of the pivoting motion of the reflector or collector during tracking to provide automatic cleaning of the surface while the reflector or collector pivots. The system includes a wiping device disposed on the surface of the reflector or collector, and a counterbalance device coupled to the wiping device over the top end of the reflector/collector to cause the wiping device to move along the surface of the reflector or collector by means of a force exerted by the counterbalance device, and clean the surface. The counterbalance device coupled to the wiping device can be a counterweight, or a spring coupled to the wiping device and disposed behind or beside the reflector or collector, or an anchor affixed to a fixed element on or near the structure, such as the pylon supporting the pivoting mechanism.

It is a particular feature of the present invention that no external energy mechanism is required to move the wiping device. Rather, the pivoting mechanism of the reflector or collector that pivots it during its normal tracking operation causes the wiping device to move along the surface of the reflector or collector under the force of gravity, or under the counterbalance force, and clean it. It will be appreciated that the counterbalance device is required in order to return the wiping device to the top end of the reflector or collector. The pivoting mechanism causes the reflector pr collector to pivot between a first state, wherein the wiping device moves to the top end of the reflector/collector by means of a counterbalance force exerted by the counterbalance device on the wiping device, during which the wiping device cleans the reflector/collector, and a second state wherein the wiping device moves to a bottom end of reflector/collector by means of gravity and cleans the reflector/collector.

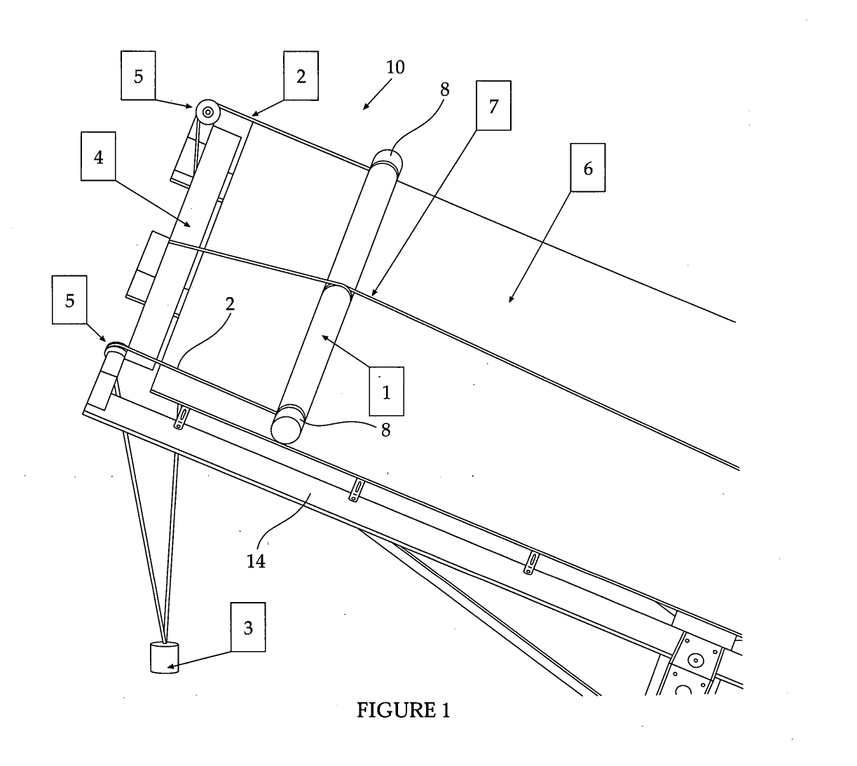

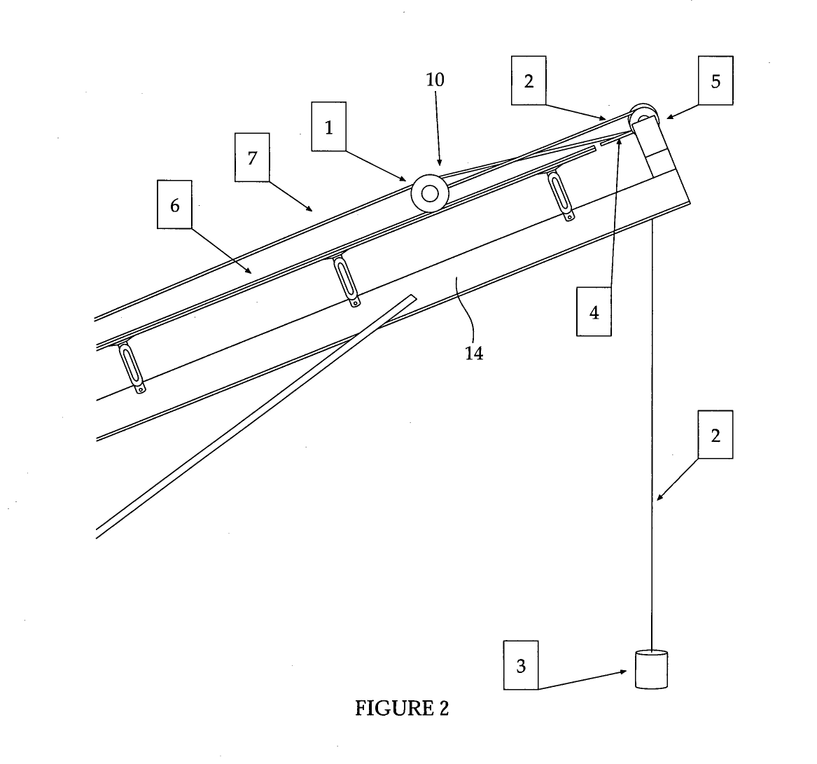

Referring now to FIGS. 1 and 2, there are shown a top perspective and side view, respectively, of a system (10) for cleaning a reflector or collector (6), constructed and operative in accordance with one embodiment of the present invention. Reflector or collector (6) is mounted in a frame (14), as known, having a pivot mechanism (16) for causing it to pivot automatically during collection of the sun's rays.

System (10) includes a wiping device (1) placed horizontally across the surface of the reflector or collector (6) to be cleaned, when the reflector or collector is facing upwards. The wiping device can be made of sponge, fabric, a brush, etc., and can be flat or cylindrical, or of any other desired shape. The wiping device (1) is coupled by wires (2) to a counterbalance device (3), here illustrated as a counterweight, over the top end of the reflector/collector. The counterbalance device (3) preferably exerts a counter force equal to the force of gravity acting on the wiping device (1) when the reflector or collector is at an angle of about 45°. The counterbalance device (3) may be disposed behind or beside the reflector or collector surface during use. The angle at which the wiper begins to move to the other end of the reflector can be set by fixing the ratio of the weight of the counterweight to the wiping device.

Typically, the mirror will be cleaned twice a day—once when the wiper moves from top to bottom of the reflector or collector and once when the wiper moves from the bottom to the top. On the top and bottom ends of the reflector or collector surface, a “parking” station (4) is preferably provided for the wiper (1), where the wiper can sit when the cleaning process is not taking place, to prevent the wiper from blocking the sun's rays. Two low friction mechanisms (5), such as pulleys, may be mounted on the top edge of the reflector/collector to allow the wires (2) to slide smoothly. When it is desired to provide a counter rolling motion to the wiper for improved cleaning, including brushing off the dirt, a wire (or chain) (7) may be wrapped around the wiping device and may engage a gear wheel (not shown), in order to turn the wiper counter to its natural rolling direction during cleaning.

According to one preferred embodiment, illustrated in FIG. 1, the counterbalance device (3) is a counterweight, and the wiper (1) is a cylindrical brush mounted on two wheels (8) or slide elements. The counterweight (3) is lighter in weight than the brush (1).

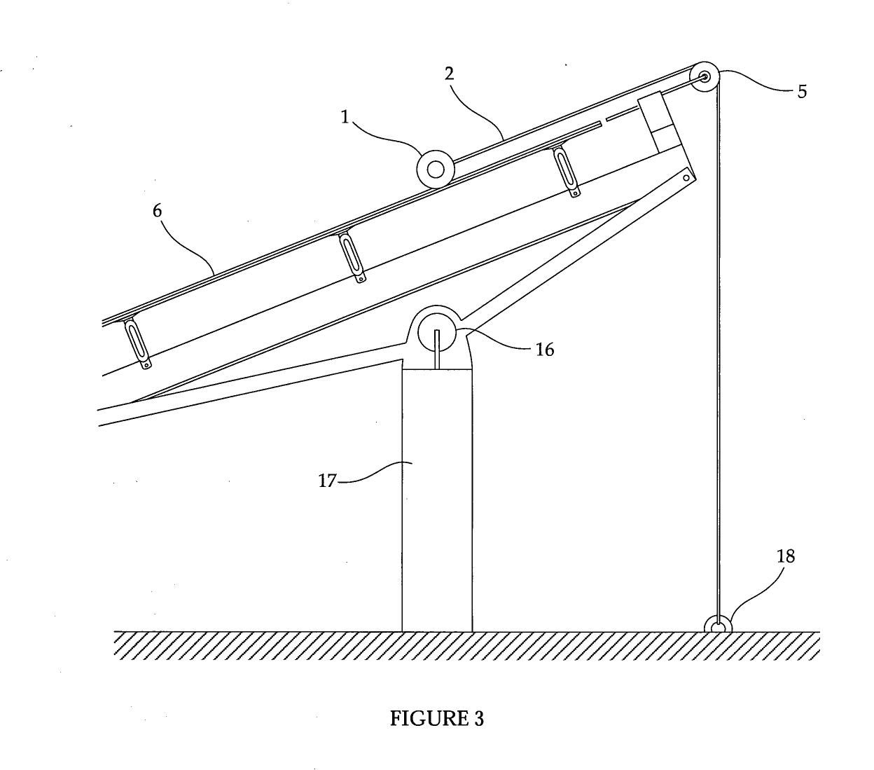

Another way to achieve the desired upwards motion of the wiping device along the reflector/collector is shown in FIG. 3, a schematic side view of a system for cleaning reflectors or collectors, according to an alternative embodiment of the present invention. In this example, the wiping device (1) is coupled over the top end of the reflector/collector (6) to an anchor (18), which acts as a counterbalance device by anchoring the wiping device to a stationary element located outside of the pivoting mechanism (17), not at the pivot center, for example, to the pylon holding the pivoting mechanism.

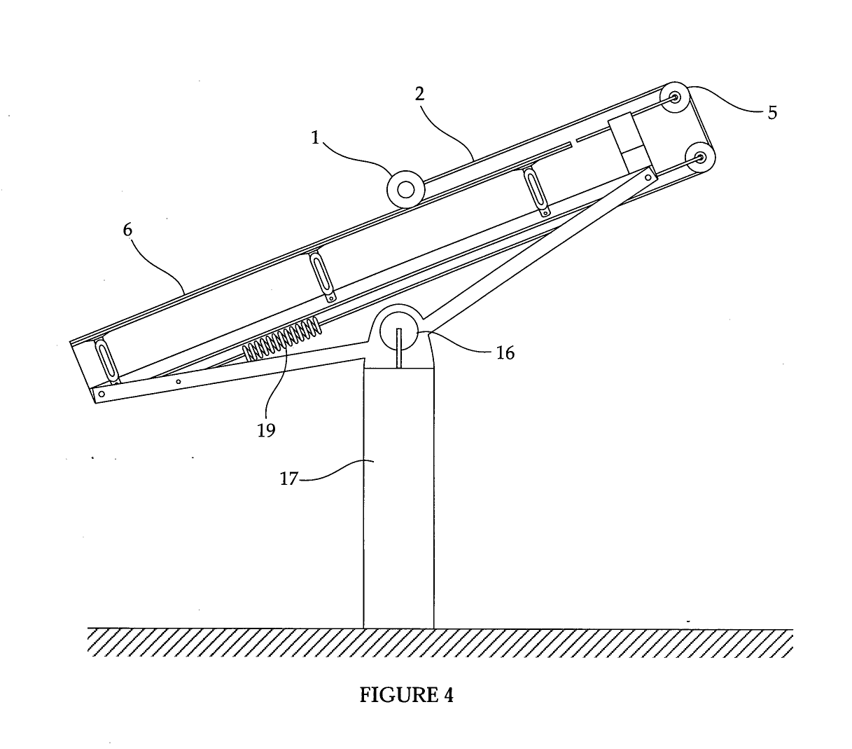

FIG. 4 is a schematic side view of a system for cleaning a reflector/collector wherein the counterbalance device is a spring, for example, a balancer or spiral spring. As can be seen, spring (19) is affixed to the side of reflector/collector (6) facing away from the sun and is coupled about the top end of the reflector/collector to the wiping device (1). As the reflector/collector pivots to its vertical position, the gravity acting on wiping device (1) causes it to move down the reflector or collector, thereby loading spring (19). As the reflector/collector pivots back to its horizontal position, the tension in the spring provides a counterbalance force which pulls the wiping device back to the top of the reflector/collector.

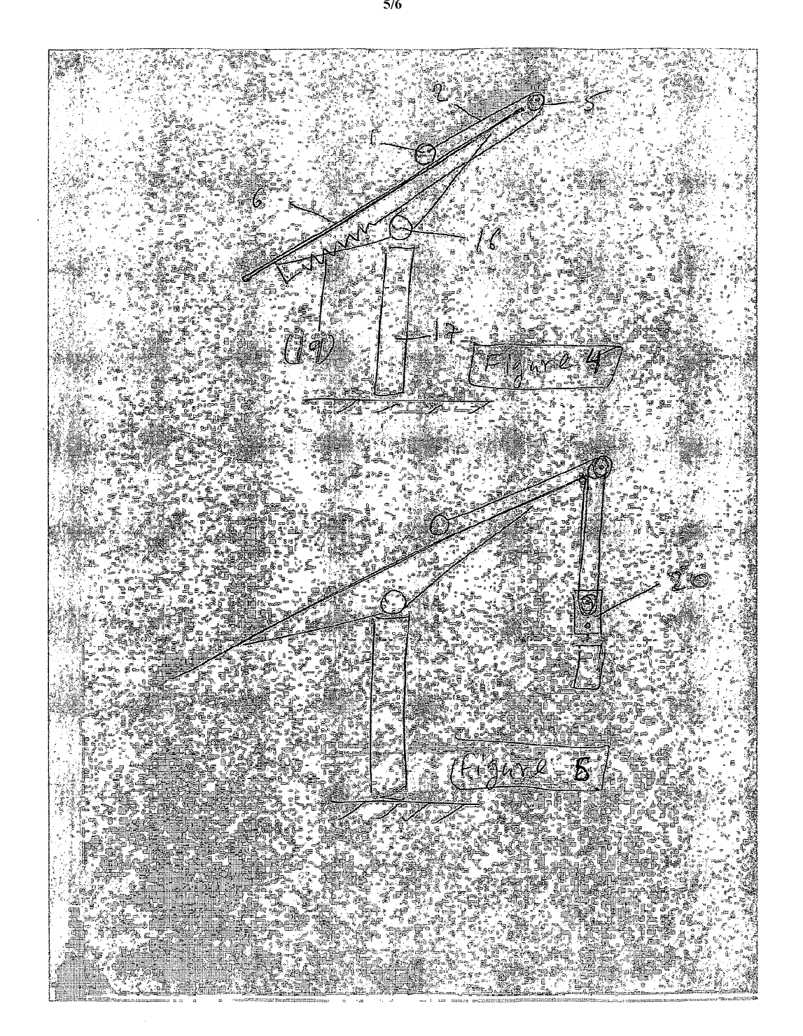

In case the length of the surface to be cleaned (the length of the reflector or collector) is longer than its height from the ground, as shown in FIG. 5, a compensator is needed, to prevent the wiping device from stopping before the end position due to the counterbalance device reaching the ground or the wires (2) holding the wiping device being too long. In this case, a pulley block (20) can be used. The pulley block changes the ratio of the weight of the wiping device to the counterbalance device in a way that a small movement of the counterbalance device (weight (3), spring (19) etc) will create greater movement of the wiping device.

Operation of the system, i.e., the cleaning process, is as follows. The reflector/collector (6) pivots as determined by the pivot mechanism (16), as known. When the reflector/collector (6) reaches an angle facing towards the horizon, the imbalance between the counterbalance device and the wiper (1) causes the wiper to slide or roll downward under the force of gravity along the reflector/collector surface (6). As the reflector/collector pivots and reaches an angle facing upward to the sky (about 90°), the counterbalance force of the counterbalance device, for example, the unbalanced force vectors between the weight and the wiping device, cause the wiper to slide or roll upwards along the reflector/collector surface (6). Thus, the reflector/collector (6) is cleaned both as the wiper moves downwards and as it moves upwards along the surface (6). When an extra wire set (7) is provided, or other suitable mechanism, the wiper will rotate in the direction opposite to the rolling direction during cleaning.

There are several ways to create cycling repetitive motion for the cleaning process. One way is to rely on the daily tracking movement of the reflector/collector. Alternatively or in addition, the pivoting mechanism of the reflector/collector can be programmed to purposely pivot through 90° motions at a desired frequency and at a specific time of the day.

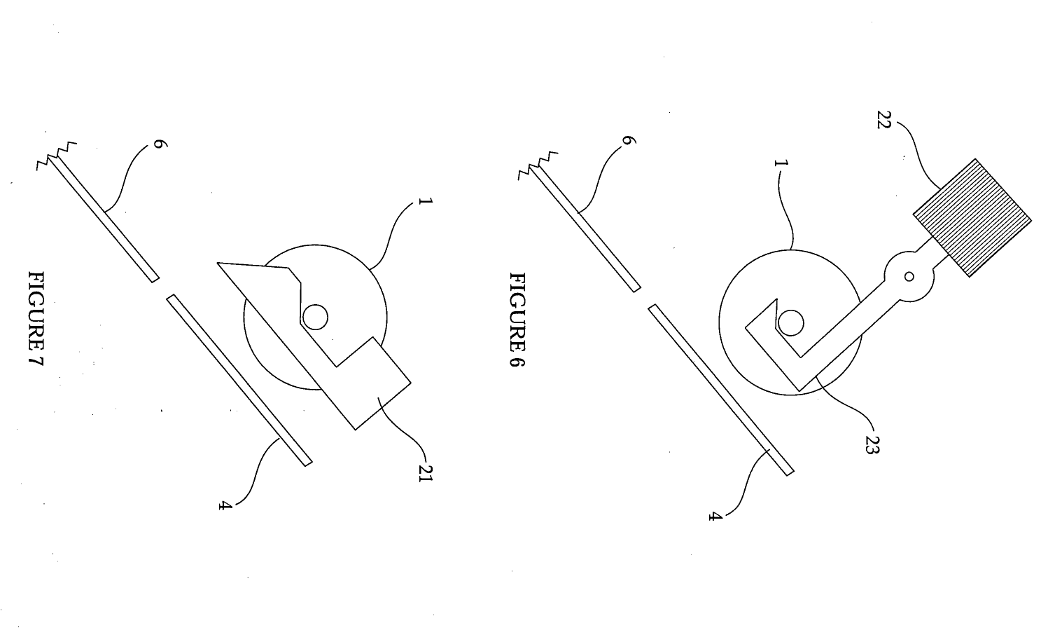

In order to provide a greater speed of the wiping motion, it is possible to mount a latch on the parking station (4). The latch will releasably hold the wiping device by changing the angle at which the wiping device begins to move during the cleaning process, i.e., when the force of gravity or the counterbalance force is great enough to overcome the resistance of the latch. The latch can be a dynamic latch (23), as shown in FIG. 6. Latch (23) will hold the wiper at the end position (i.e., in the parking station) until the proper angle is achieved and then release it for cleaning. Only when the weight of the wiping device exceeds the weight (22) of the latch holding it in place, the latch will open and release the wiping device, and the wiping device will slide down along the face of the reflector/collector. When a static latch (21), shown in FIG. 7, is used, the weight and the angle of the wiping device must exceed the geometric barrier in order for the wiping device to slide down the reflector/collector.

Advantages of the present invention include:

1. Using the existing motion of the “tracking” system to generate cycling in the cleaning process.

2. Receiving high quality surface cleaning with dry process and large numbers of cycles.

3. Utilizing gravity and geometric relations between parts to create wiper cycled motion.

4. Implementation of this system in thermal energy systems, such as heliostats (HL and parabolic trough) and Photo Voltaic systems.

5. An integral cleaning system that is placed on the reflector/collector construction. Every reflector/collector, in the solar system field, has an individual cleaning system of its own.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A system for cleaning a reflector/collector pivotally mounted on a pivoting mechanism, the system comprising:
a wiping device disposed on one side of the reflector/collector; and
a counterbalance device coupled to said wiping device over a top end of the reflector/collector;
wherein said pivoting mechanism causes the reflector/collector to pivot between a first state wherein said wiping device moves to said top end of the reflector/collector by means of a counterbalance force exerted by said counterbalance device and cleans the reflector/collector by a dry process, and a second state wherein said wiping device moves to a bottom end of reflector/collector by means of gravity and cleans the reflector/collector by said dry process.

2. The system according to claim 1, wherein said counterbalance device is selected from the group including: a counterweight, a spring, and an anchor affixed to a fixed element near the reflector/collector.

3. The system according to claim 2, wherein said anchor is affixed to a pylon holding the reflector/collector.

4. The system according to claim 1, further comprising a parking station at each end of said reflector/collector for holding said wiping device when not cleaning.

5. The system according to claim 4, wherein said parking station includes a latch for releasably holding said wiping device when not cleaning.

6. A method of cleaning a surface of a reflector/collector pivotally mounted on a pivoting mechanism, the method comprising:
disposing a wiper on the surface of the reflector/collector;
counterbalancing said wiper over a top end of the reflector/collector; and
pivoting the reflector/collector by means of said pivoting mechanism between a first state wherein said wiping device moves to said top end of the reflector/collector by means of a counterbalance force from said counterbalance device and cleans the reflector/collector by a dry process, and a second state wherein said wiping device moves to a bottom end of reflector/collector by means of gravity and cleans the reflector/collector by said dry process.

7. The method according to claim 6, wherein said counterbalance device is selected from the group including: a counterweight, a spring, and an anchor affixed to a fixed element near the reflector/collector.

8. The method according to claim 6, further comprising providing a parking station at each end of said reflector/collector for holding said wiping device when not cleaning.

9. The method according to claim 8, further comprising releasably holding said wiping device in said parking station when not cleaning.

10. A solar system field comprising:
at least two reflector/collectors, each reflector/collector pivotally mounted on its own pivoting mechanism, each said reflector/collector having an individual cleaning system according to claim 1.

11. The method according to claim 6, further comprising;
providing at least a second reflector/collector pivotally mounted on its own pivoting mechanism;
disposing an individual wiper on the surface of each said at least a second reflector/collector;
individually counterbalancing each said individual wiper over a top end of the reflector/collector; and
pivoting the reflector/collector by means of said pivoting mechanism between a first state wherein said individual wiper moves to the top end of the second reflector/collector by means of a counterbalance force from said counterbalance device and cleans the reflector/collector by said dry process, and a second state wherein said individual wiper moves to a bottom end of said second reflector/collector by means of gravity and cleans the reflector/collector by said dry process.
